(19) United States
(12) Patent Application Publication
(10) Pub. No.: US 2007/0013665 A1
(43) Pub. Date: Jan. 18, 2007

(54) Method for shifting a shortcut in an electronic device, a display unit of the device, and an electronic device

(76) Inventors: Asko Vetelainen, Jaali (FI); Markku Autio, Oulu (FI)

Correspondence Address: HARRINGTON & SMITH, LLP, 4 RESEARCH DRIVE, SHELTON, CT, 06484-6212, US

(21) Appl. No.: 10/575,053

(22) PCT Filed: Oct. 7, 2004
(86) PCT No.: PCT/FI04/00592

§ 371 Date: Apr. 6, 2006

(30) Foreign Application Priority Data
Oct. 24, 2003 (FI) 20031563

(51) Int. Cl. G09G 5/00

(52) U.S. Cl. 345/169

(57) ABSTRACT

The object of the invention is a method for shifting the contents of a first shortcut key (e.g. 26) belonging to the shortcut menu of the user interface of an electronic device to become the contents of a second shortcut key (e.g. 22) belonging to the same shortcut menu. An object of the invention is also an electronic device, a touch display used in the device, and an application program utilised in the device. In the method according to the invention the contents of a shortcut key (26) on the display (20) of an electronic device can be shifted to become the contents of a second shortcut key (22) using the drag and drop method.

The object of the invention is a method for shifting the contents of a shortcut key belonging to the user interface of an electronic device to become the contents of a second shortcut key. An object of the invention is also an electronic device utilising the method, a touch display used in the device, a software application utilised in the device, and a computer program on a data storage means.

An electronic device is utilised with the aid of its user interface. In some devices, such as in conventional Personal Computers (PC), the user interface comprises a display and a separate keyboard. The PC can be controlled both through the keyboard and through a separate mouse realising a graphical user interface. There are also such known display solutions where the PC display unit is realised by a so-called touch display principle. Then touching a certain part of the display or pushing it with an object, such as a finger, a pen or a pointing pin will activate a function programmed in the device.

The PC world also knows the so-called drag and drop method, where a click on one mouse button selects an object shown on the PC display, and while the selection is kept active the object on the display is dragged above a second object on the display where the mouse button then is released. This action shifts the whole selected object, if it is a file or the like, to become the contents of the second object. The shifted file or object either replaces another file with the same name within the second object, or the shifted file is attached to become a part of this second object. Thus this action can shift entire files from one object to another. In the same way the location of a certain icon, which can activate a function, may be shifted on the so-called desktop. However, shifting of an icon will not affect the location or the functions of other icons on the desktop.

In some electronic devices, such as in cellular network terminals, in portable computers or PCs, it is possible to make so-called shortcut keys or shortcut buttons which form a shortcut menu serving the user.

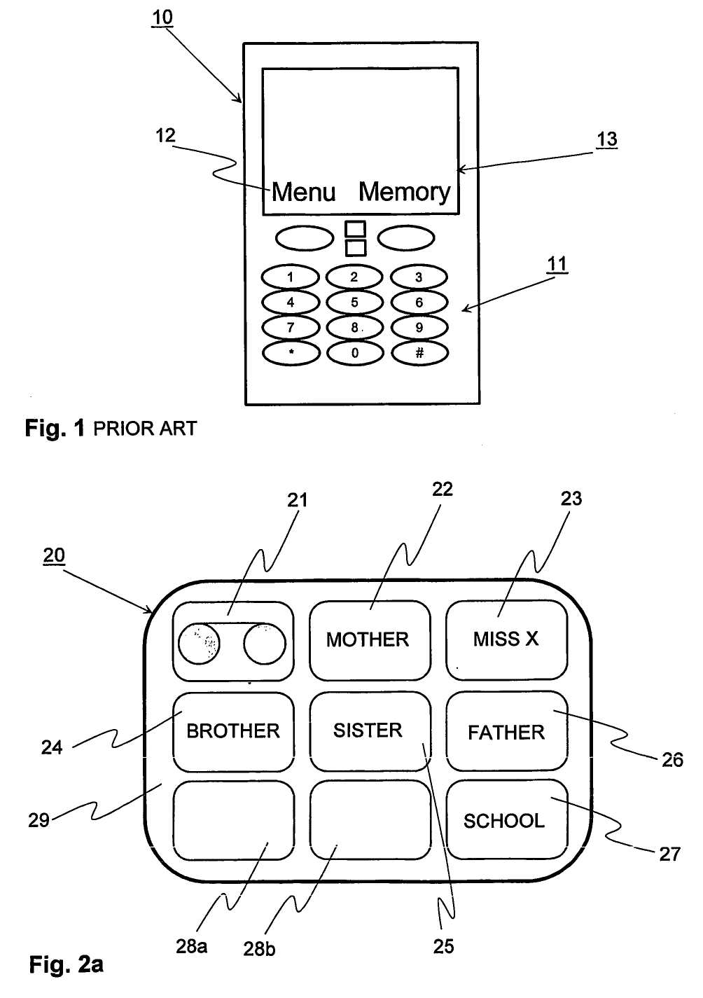

FIG. 1 shows an example of a prior art cellular network terminal 10 utilising shortcut keys. Thus the terminal 10 according to FIG. 1 has certain physical number keys 11, which can be defined as shortcut keys. This means that by pressing a certain physical key 11 one can execute a desired operation, which can be for instance the entering of a long telephone number and the connection instruction. In this way the user of the terminal can define for instance that the depression of a certain key 11 always causes a transmission connection to be established to a certain other terminal.

In conventional cellular network terminals 10 the making of a shortcut menu is realised so that with the aid of a menu procedure 12 the user can define shortcut operations, which relate to certain keys/buttons 11. The menu 12 used for creating the shortcuts is opened on the display 13 of the terminal 10. The shortcuts must always be deleted, changed or added using said menu 12. Because it is inconvenient to change the shortcut menu through the menu 12, this contributes to reducing the user's desire to change his or her shortcut menu.

In the terminal 10 according to FIG. 1 it is also possible to utilise a prior art touch screen. Then it is also possible to realise the number and function keys 11 using the touch screen techniques. This kind of prior art terminals also utilise the definition of shortcut keys via the menu 12.

In connection with a PC it is correspondingly possible to define for certain keys different macro instructions, which the user will often need.

However, the user of a cellular network terminal, a portable computer or PC has a need to continuously adapt the device in his or her personal use to be such that the desired actions can be performed rapidly and easily. This can be called personalising the user interface. In practice this means that the most often used or the most important shortcut keys are located at a place in the user interface desired by the user. These user desires may change rapidly, so that an easy method for changing the shortcuts is important. A contributing factor in attaining these objects is, if the changing of an individual terminal's shortcut menu could be made more easily than what is possible in prior art terminals for instance through the menu procedure.

An object of present invention is to provide a method and an electronic device utilising the method, such as a cellular network terminal, a portable computer or PC, where a shortcut menu can be personalised without a prior art selection menu. The shortcut menu according to the invention can be located on the touch screen of the electronic device.

The object of the invention is attained with a procedure where a shortcut key created on the user interface, such as on the display of the electronic device, and also the contents and functionality relating to the shortcut key can be shifted to become the contents and functionality of another shortcut key with the aid of a drag and drop procedure.

An advantage of the invention is that the changing of the contents of shortcuts or shortcut keys in the user interface of an electronic device can be made without a prior art menu procedure.

A further advantage of the invention is that the contents of two shortcuts or shortcut keys can be interchanged without a menu procedure.

A further advantage of the invention is that the contents of a shortcut or shortcut key can be shifted either in the display of the electronic device or in the physical keyboard belonging to the electronic device.

A further advantage of the invention is that the shifting of a shortcut or shortcut key can be cancelled during shifting, without any separate extra procedures via a menu.

The method according to the invention for shifting the contents of a first shortcut key belonging to the shortcut menu of the device's user interface to become the contents of a second shortcut key is characterised in that the contents of the first shortcut key is shifted to become the contents of the second shortcut key with the drag and drop method.

A touch screen according to the invention is characterised in that the shifting of the contents of a first shortcut key into a second shortcut key is arranged to be performed by the drag and drop method.

An electronic device according to the invention is characterized in that the shifting of the contents of a first shortcut key on the display of the electronic device to become the contents of a second shortcut key is arranged to be made with the drag and drop method.

An application program according to the invention stored in an electronic device is characterised in that the application program comprises software means for performing the shifting of the contents of a shortcut key utilising the drag and drop method.

A computer program according to the invention on a data storage means is characterised in that it comprises software means, which can be used to shift the contents of a shortcut key in the display of the electronic device to become the contents of a second shortcut key utilising the drag and drop method.

Some advantageous embodiments of the invention are presented in the dependent claims.

The basic idea of the invention is as follows: The user interface of the electronic device includes a display and keys, which control the operation of the electronic device. The user interface can also include a shortcut menu, which can be personalised by the user, and with which the functions selected by the user can be executed in one operating procedure when desired. The actual shortcut menu or the shortcut keys used in shaping it are realised for instance in the display unit of the electronic device.

If the display unit is for instance a prior art touch screen, then the shortcut to a certain function can be performed by touching a touch sensitive object on the display, a shortcut key. When one wants to change the place of a certain shortcut key on the touch screen one proceeds as follow. The shortcut key to be shifted is selected by pressing it or by pointing at it, for instance with a finger. Then one moves the finger on the touch screen towards a second shortcut key, into which one wants to shift the functions of the first selected key. When the finger has been moved onto that shortcut key into which one wants to shift the first selected shortcut key, then one releases the finger from the touch screen. Then the selected first shortcut key and the second shortcut key, onto which the finger was moved, interchange their contents and functions. Thus the first selected shortcut key is now at the desired position on the display, and the functions and data of the second shortcut key have been shifted into its former place. If the shift is made into a shortcut key, which has no defined function, then the original place of the first shortcut key will correspondingly remain without functions when the shift is completed.

The invention is described in detail below. The description refers to the enclosed figures, in which

FIG. 1 shows a prior art terminal, where at least a part of the keys can be defined to be shortcut keys;

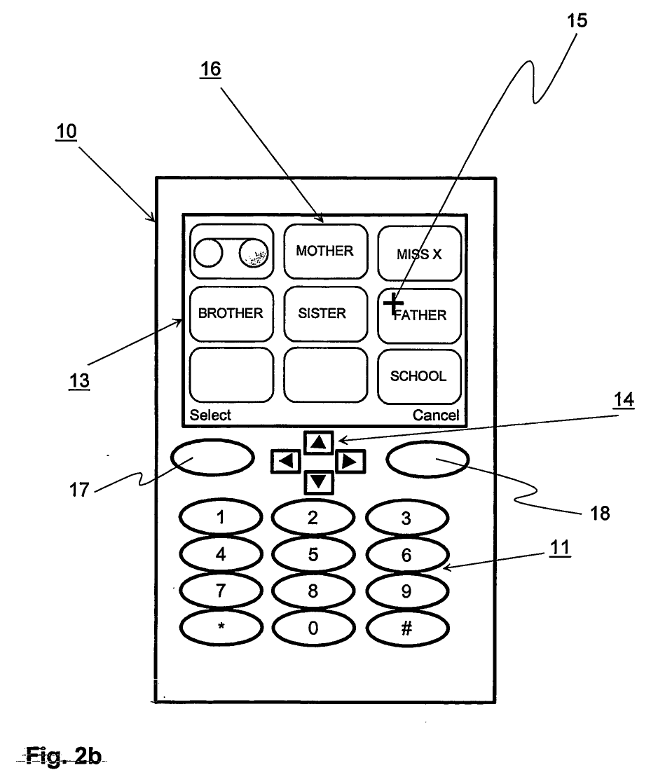

FIG. 2a shows as an example a first embodiment according to the invention in an electronic device utilising a touch screen unit;

FIG. 2b shows as an example a second embodiment according to the invention in an electronic device, which does not utilise a touch screen;

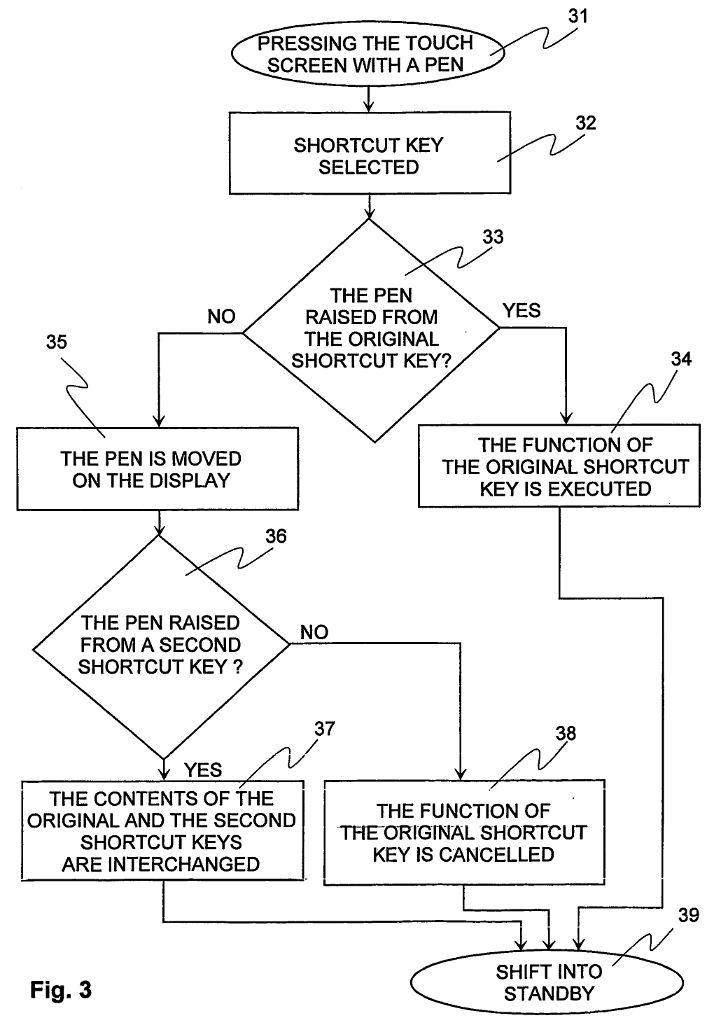

FIG. 3 shows the main steps of a method according to the invention; and

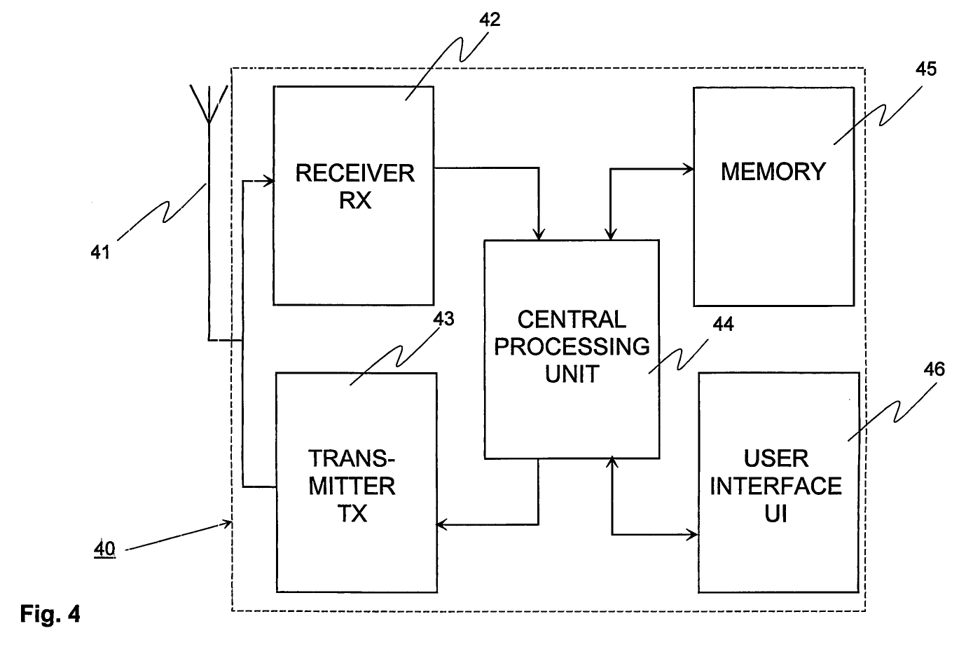

FIG. 4 shows as an example a cellular network terminal according to the invention.

FIG. 1 was explained in connection with the description of prior art.

The invention is described in more detail with the aid of the following exemplary embodiments. A cellular network terminal is used as an example to aid the description. To a person skilled in the art it is obvious that a method according to the invention can be utilised also in other electronic devices having as the user interface either a touch screen or a graphic user interface. The property, which is mentioned in the description below, and which is shifted with the aid of the method according to the invention, is the contents of a key or an icon. In this context the contents means for instance the following objects related to a certain key: the actual function of the key, the appearance of the key on the display in use, a macro instruction, a picture, text, or contact information.

FIG. 2a shows an example of a display unit 20 included in the user interface of an electronic device according to the invention. The display unit 20 can be for instance a prior art touch screen. The actual electronic device is not entirely shown in the example of FIG. 2a. Thus the user interface of the electronic device can also include other components and functions than those shown in FIG. 2a. The size of the display unit 20 is determined in accordance with the size of the actual electronic device. If the electronic device is for instance a cellular network terminal it is assumed to be of a quite small size. Thus also the display unit 20 belonging to it is small, even if it would almost entirely occupy a certain surface of the terminal. Regarding a terminal of this kind the example in FIG. 2 contains nine exemplary shortcut keys 21 to 28b on the terminal's display 20. Then the area reserved for a single shortcut key remains large enough for the user. A single shortcut key 21-28b is activated by pushing it with some object, such as with a finger, a pen or a pointer pin. The shortcut keys 21-28b on the display 20 form the shortcut menu of the electronic device. Each shortcut key 21-28b is able to perform the operation attached to it, which operation in this example is the establishment of a transmission connection to a certain other device.

In the cellular network terminal's display unit 20, depicted in FIG. 2a, a limited area is defined on its surface for each shortcut key, and by manipulating this area the shortcut key in question will perform the operation defined for it. The shortcut keys 21-28b are separated by an area 29, which is not related to any operation. The area 29 prevents any erroneous functions, which could arise if the shortcut keys 21-28b would have continuous edges touching each other.

There may be at least two kinds of shortcut keys. An example of the first kind is the shortcut key 21, which represents the initiation of listening to voice messages sent to the terminal's user. A shortcut key of this kind is made permanent, and its position or functional contents can't be shifted with the method according to the invention. It can be movable or removable by using the prior art menu method. There can of course be other such permanent shortcut keys than the single permanent shortcut key 21 shown in FIG. 2a.

The invention is well applicable to the shortcut keys of the second kind, which are the shortcut keys 22 to 28b in the display unit 20 shown in the example of FIG. 2a. To these keys the user has added functions, which to the user are important or desirable, but the importance of which may change in the course of time. As the example of FIG. 2a concerns a cellular network terminal the display unit 20 shows shortcut keys 22-28b, which are associated with procedures for establishing a connection to a terminal of a certain person or organisation. In the example of FIG. 2a the user has created the following shortcut keys: mother 22, miss X 23, brother 24, sister 25, father 26 and school 27. The shortcut keys 28a and 28b are not associated with any functions.

The method according to the invention is utilised in the following way. The user wishes for instance to interchange the shortcut keys of mother 22 and father 26 including their contents. In the first phase the user then selects either one of the mentioned shortcut keys by depressing it or by pointing at it for instance by a pen or a finger. If the selected shortcut key is father 26, the user moves the pen along the surface of the touch screen 20 above the shortcut key mother 22. When the pen is on the shortcut key 22 the user raises the pen from the surface of the touch screen 20. Raising the pen causes the contents of the shortcut keys 22 and 26 to be interchanged. Then the situation is such that the father's shortcut is located at the shortcut key 22, and the mother's shortcut is located at the shortcut key 26. Thus the two shortcut keys on the display have interchanged their contents in accordance with the invention.

If the user of the device wants to cancel the shifting of the shortcut keys being executed, it is performed as follows. The user raises the pen from the surface of the touch screen 20 in such a portion of the display, which is not defined to act as a shortcut key. This cancels the initiated shifting of the shortcut key.

If the user on the other hands raises the pen from the touch screen 20 at that shortcut key, which he originally selected by pushing with the pen, in the example above father 26, then there is performed the function relating to said shortcut key, i.e. the device tries to establish a connection to the father's terminal. In a terminal utilising the method according to the invention the shortcut key function is activated only when the object, such as a finger or pen is raised from the selected shortcut key.

If the user wants to shift a shortcut key used by him, for instance school 27, to a shortcut key still unused, for instance the shortcut keys 28a or 28b in FIG. 2a, then the shift is made in the manner described above. If the shift is made into the shortcut key 28a, then the user raises his pen from the surface of the touch screen over the shortcut key 28a. Then the shortcut key school 27 is shifted into the shortcut key 28a. That shortcut key 28a, into which the shift was made, was empty at the shifting moment. As a consequence, the original shortcut key 27 will now change into an empty shortcut key. Thus this key does not anymore relate to any functions.

Above we described how the invention is utilised in such cellular network terminals, which use a touch screen. It is also possible to utilise the invention in terminals without a touch screen. FIG. 2b shows a cellular network terminal 10 representing prior art. The terminal 10 has a display unit 13, which is not a touch screen. The terminal 10 further contains a prior art keyboard 11, a four-way key 14 and keys 17 and 18. In the example of FIG. 2b the key 17 activates the function “Select” on the display 13, and the key 18 activates the function “Cancel”. Of course the functions selected by the keys 17 and 18 can also be other functions than the alternatives shown in the example of FIG. 2b.

A shortcut menu 16 comprising nine shortcuts is created on the display of the terminal 10 in order to apply the invention. The number of keys in the shortcut menu 16 and their contents are only examples. The four-way key 14 can move the cursor 15 on the display 13. Two shortcut keys can be interchanged according to the invention as follows. The cursor 15 is moved with the aid of the four-way key 14 above another shortcut key, which shall be interchanged. In the example of FIG. 2b the shortcut key, which contains the connection establishment routine to fathers terminal. The shortcut key “father” is selected for instance with the key 17 “Select”. The cursor 15 is moved with the aid of the four-way key 14 over the shortcut key “mother”. The positions of the shortcut keys are interchanged for instance by pressing again the key 17 “Select”. If one wants to cancel the initiated shifting it can be made for instance by pressing the key 18 “Cancel”. If one only wants to establish a connection to fathers terminal one double-clicks the key 17 when the cursor is above the shortcut key “father”.

The method according to the invention can be applied in connection with different so-called virtual keyboards. In this context a virtual keyboard means such device arrangements, which do not have a physical keyboard, but the keyboard is optically projected on a suitable surface. An example of a possible virtual keyboard is presented in the same applicant's Finnish patent application FI 20002752. With the aid of the device arrangement presented in this application it is possible to detect whether for instance a finger is on that surface, on which the virtual keyboard was created, or whether it is above this surface. Thus a virtual keyboard of this kind functionally corresponds to the touch screen 20 shown in connection with figure 2a. Such virtual displays can be very large. With the aid of them it is thus possible to create entire computer keyboards or the like. With the aid of a method according to the invention the user of the device can modify the virtual keyboard to meet the users desires exactly.

The invention can be applied also in connection with a portable computer, a palm computer or a PC. Then it can be utilised for instance either to shift the contents of icons on the PC's display or also to interchange the macro instructions attached to the physical keyboard. Functionally the shifting of icons on the PC's display unit is almost similar to the case described above in a cellular network terminal, where a shortcut was shifted with the aid a four-way key and one selection key.

In connection with a PC the contents of two icons on the display can be interchanged for instance with the aid of a mouse connected to the device. Then the icon to be shifted is seized in a prior art manner with the aid of a button in the mouse, and the mouse cursor with an active selection is moved above another icon on the display. Because the movement is terminated above another icon this means that the contents of the icons in question should be interchanged. If the icon is moved into an empty position on the PC's display the icon is shifted to this position, and its contents will not be interchanged with another icon.

If the invention is applied to shift a macro instruction attached to a physical key in a PC, this can be made for instance in the following way. In order to perform the shifting the PC display generates a picture for instance of that key, to which macro instructions are attached. Of course it is also possible to generate a picture of the entire PC keyboard in use. Then a macro instruction can be shifted into another key in the created picture, for instance with the aid of the PC mouse in the manner described above. The desired key in the display picture is selected with a mouse button, and then the mouse cursor is moved above another key. If the shift of the macro instruction is terminated above a key attached to another macro instruction, then the macro instructions attached to the keys are interchanged in the same manner, which was presented above in the example concerning a cellular network terminal. When the desired macro instruction shifts are completed, then the keyboard picture created in the PC display is closed, and the macro instructions have been attached to new keys of the physical keyboard.

FIG. 3 shows as an exemplary flow diagram the main steps of a method according to the invention, for instance when the invention is utilised in a cellular network terminal. The exemplary touch screen according to FIG. 2a, which can be utilised in said terminal, is further used to aid the description of the method.

In step 31 the user of the device presses the desired shortcut key on the touch screen 20. The key can be pressed for instance with a finger or with some object, such as a pen. The shortcut key is selected, when it is pressed, step 32.

Only when the pen is raised from the surface of the touch screen 20 the function attached to the shortcut key is activated in a terminal according to the invention. Step 33 therefore examines whether the pen was raised from the surface of the touch screen 20 at the position of the originally in step 32 selected shortcut key or not. If the pen was raised at the originally selected shortcut key, alternative YES, the operation continues in step 34, where the function attached to this selected shortcut key is performed. When the function has been performed the operation continues in step 39, where the terminal is in the standby state for the users next action.

If step 33 results in the alternative NO, this means that the pen is moved on the surface of the touch screen 20, away from the originally selected shortcut key, step 35. In some phase the pen is finally raised from the touch screen 20. Step 36 examines at which position of the touch screen 20 the pen was raised. If the pen was raised at a region 29, which does not belong to any shortcut key, the alternative NO is selected. The alternative NO leads to step 38, where the original selection of the shortcut key made in step 32 is cancelled. As the selection is cancelled, it also means that the shift of the shortcut key according to the invention is also interrupted and cancelled at the same time. When the operation is cancelled it leads to step 39, where the terminal is in the standby state waiting for the user's next action.

If step 36 results in the alternative YES, this means that the pen has been moved above a second shortcut key, and that the pen was raised from the touch screen 20 at this second key. The result YES means that the user wants to interchange the contents of these two shortcut keys. The contents of the shortcut keys are interchanged in step 37. When the contents of the shortcut keys have been successfully interchanged, then the operation leads to step 39, where the terminal is in the standby state waiting for the user's next action.

The steps of the method in FIG. 3 can be realised in the terminal by an application program according to the invention stored in the terminal. If the terminal comprises several modules, the application program according to the invention can be included for instance also in the control electronics belonging to the touch screen.

Of course the method according to FIG. 3 can be utilised in any electronic device with a user interface including a display and a keyboard. The display can be either a touch screen or a conventional display using a graphic user interface. Examples of such devices are a PC, a portable computer, a palm computer or the like. The application of the invention in these requires an application program, which realises the functions presented in the flow diagram of FIG. 3.

FIG. 4 shows as an exemplary flow diagram a cellular network terminal 40, where the method according to the invention can be utilised. The terminal 40 shown in FIG. 4 uses the antenna 41 in transmitting and receiving signals to and from the cellular network serving the terminal. The reference numeral 42 represents means forming a receiver RX, with which the terminal 40 receives messages from the cellular network serving it. The receiver RX comprises prior art means for all received messages or signals.

The reference numeral 43 represents means forming the transmitter TX of the wireless terminal 40. The transmitter means 43 perform all signal processing procedures required in the operation with the cellular network serving it.

The terminal 40 includes a control unit 44 controlling its operation. It controls the operation of all main components belonging to the terminal 40. It controls both the transmission and reception functions. It controls also the terminal's user interface UI 46, which also can comprise a touch screen, and the memory 45 belonging to the terminal. The application program according to the invention can be stored in the terminal's 40 memory 45, from where the central processing unit 44 of the terminal 40 then can utilise the program.

In an embodiment of the invention all actions required by the method according to the invention are thus performed under the control of the central processing unit 44. In this embodiment the central processing unit controls also the operation of the terminal's touch screen.

In another embodiment of the invention the application program required by the method according to the invention is included in the control module of the touch screen belonging the terminal's user interface 46. The control module can be realised by some prior art manufacturing method. In this embodiment the control module of the touch screen takes care of at least a part of the procedures required by the method according to the invention. In this embodiment at least a part of the application program according to the invention is stored in the control module.

Above we have described some advantageous embodiments of the method and device according to the invention. The invention is not limited to the described embodiments, but the inventive idea can be applied in numerous ways within the scope presented in the claims.

1. A method for shifting the contents of a first shortcut key and a second shortcut key belonging to the user interface of an electronic device, characterised in that the contents of the first shortcut key and the second shortcut key is shifted between each other with the aid of a drag and drop method.

2. The method according to claim 1, characterised in that one of the following is used as the electronic device: a cellular network terminal, a PC, a portable computer or a palm computer.

3. The method according to claim 2, characterised in that a touch screen is used as the display unit of the electronic device, whereby a shortcut menu is created on the touch screen.

4. The method according to claim 3, characterised in that the first shortcut key to be shifted is selected to become the shifted shortcut key by pressing the touch screen with the aid of an object at the position of the first shortcut key.

5. The method according to claim 4, characterised in that the contents of the first shortcut key is shifted to become the contents of the second shortcut key by moving the object used in the selection on the touch screen from a position above the first shortcut key to a position over the second shortcut key, where the object is raised from the touch screen, whereby the raising of the object initiates the shifting of the contents of the first shortcut key to become the contents of the second shortcut key.

6. The method according to claim 4, characterised in that the function attached to the first shortcut key is executed if the object used to select the shortcut key is raised from the touch screen above the first shortcut key.

7. The method according to claim 4, characterised in that the raising of the object used to select the shortcut key from the touch screen somewhere else than above a shortcut key cancels the initiated shifting of the contents of the first shortcut key.

8. The method according to claim 2, characterised in that the first shortcut key is selected to become shifted by selecting it among the shortcut keys on the display of the electronic device with the button of a mouse belonging to the user interface of the electronic device.

9. The method according to claim 8, characterised in that the contents of the first shortcut key is shifted to become the contents of the second shortcut key by moving a cursor connected to the mouse on the display of the electronic device from a position above the first shortcut key to a position above the second shortcut key, where the mouse button is released, whereby the releasing of the mouse button initiates the shifting of the contents of the first shortcut key to become the contents of the second shortcut key.

10. The method according to claim 8, characterised in that if the mouse button used to select the shortcut key is released on the display of the electronic device somewhere else than above a shortcut key, then the initiated shifting of the contents of the first shortcut key is cancelled.

11. The method according to claim 9, characterised in that the shifting of a shortcut key made on the display of the electronic device further causes the functions attached to a first key belonging to the physical keyboard of the electronic device to be shifted to a second key of the keyboard.

12. The method according to claim 5, characterised in that the contents of a shortcut key means a function defined for a shortcut key.

13. A touch screen having a shortcut menu comprising at least two separate shortcut keys, a first and a second shortcut key with interchangeable contents, characterised in that the shift of the contents of the first shortcut key and the second shortcut key between each other is arranged to be made with the drag and drop method.

14. The touch screen according to claim 13, characterised in that the first shortcut key is selected to become shifted by pressing the touch screen with an object at the first shortcut key.

15. The touch screen according to claim 14, characterised in that the contents of the first shortcut key is arranged to be changed to become the contents of the second shortcut key by moving the object used for selecting on the touch screen from a position above the first shortcut key to a position above the second shortcut key, where raising of the object from the touch screen is arranged to initiate the shifting of the contents of the first shortcut key to become the contents of the second shortcut key.

16. The touch screen according to claim 14, characterised in that the function attached to the first shortcut key is arranged to be executed if the object used to select the shortcut key is raised from the touch screen above the first shortcut key.

17. The touch screen according to claim 14, characterised in that the raising of the object used to select the shortcut key from the touch screen somewhere else than above a shortcut key is arranged to cancel the initiated shifting of the contents of the first shortcut key.

18. The touch screen according to claim 15, characterised in that the contents of a shortcut key is a function defined to be executed by the shortcut key.

19. An electronic device with a user interface comprising at least two separate shortcut keys, a first and a second shortcut key with interchangeable contents, characterised in that a shift of the contents of the first shortcut key and the second shortcut key between each other is arranged to be made with the drag and drop method.

20. The electronic device according to claim 19, characterised in that the electronic device comprises a touch screen, on which there is formed a shortcut menu with at least two shortcut keys with interchangeable contents.

21. The electronic device according to claim 20, characterised in that the contents of a shortcut key is a function defined to be executed by a shortcut key.

22. The electronic device according to claim 21, characterised in that it is one of following: a cellular network terminal, a portable computer or a palm computer.

23. An application program in an electronic device for shifting the contents of a first shortcut key and a second shortcut key belonging to the device's user interface, characterised in that the application program comprises software means for executing the shift of the contents of the shortcut keys between each other utilising the drag and drop method.

24. The application program according to claim 23, characterised in that it comprises software means for changing the shortcut keys in a shortcut menu created on a touch screen, which belongs to a portable device.

25. The application program according to claim 24, characterised in that said software means realise
a step for selecting a first shortcut key, whereby the selection is made by pressing the touch screen with an object,
a step for detecting whether the object is raised from the touch screen at the position of the selected first shortcut key, and if the object is not raised at the position of the selected first shortcut key it further comprises
a step for detecting the movement of the object on the surface of the touch screen away from the position above the first shortcut key
a step for detecting whether the object is raised from the surface of the touch screen at the position of a second shortcut key and
a step where the contents of the first shortcut key and the second shortcut key are interchanged.

26. The application program according to claim 25, characterised in that it further comprises a step, in which the function connected to the first shortcut key is executed, if the object is raised from the touch screen at the position of the first shortcut key.

27. The application program according to claim 25, characterised in that it further comprises a step, where the shifting of the contents of the first shortcut key is cancelled, if the object is raised from the touch screen in an area, which is not defined to belong to a shortcut key.

28. The application program according to claim 27, characterised in that the contents of a shortcut key is a function defined to be executed by the shortcut key.

29. The application program according to claim 28, characterised in that it is arranged to be used in one of the following devices: a cellular network terminal, a portable computer or a palm computer.

30. A computer program on a data storage means, characterised in that it comprises software means, whereby the use of these software means makes it possible to shift the contents of a first shortcut key and a second shortcut key on the display of an electronic device between each other by utilising the drag and drop method.
